(19) United States
(12) Patent Application Publication
(10) Pub. No.: US 2022/0062087 A1
(43) Pub. Date: Mar. 3, 2022

(54) WALKING ASSISTANCE SYSTEM, WALKING ASSISTANCE METHOD, AND WALKING ASSISTANCE PROGRAM

(71) Applicant: Toyota Jidosha Kabushiki Kaisha, Toyota-shi Aichi-ken (JP)

(72) Inventor: Kanako Okano, Miyoshi-shi (JP)

(73) Assignee: Toyota Jidosha Kabushiki Kaisha, Toyota-shi Aichi-ken (JP)

(21) Appl. No.: 17/412,875

(22) Filed: Aug. 26, 2021

(30) Foreign Application Priority Data
Aug. 28, 2020 (JP) 2020-144446

(51) Int. Cl. A61H 3/00

(52) U.S. Cl. CPC A61H 3/00; A61H 2201/5058; A61H 2201/0165; A61H 2201/0184; A61H 2201/018; A61H 2201/16; A61H 2003/002; A61H 2003/007; A61H 2201/1418

(57) ABSTRACT

A walking assistance system includes a walking assistance apparatus attached to a leg of a user and a notification unit configured to notify the user of a predetermined state in the walking assistance apparatus. The walking assistance apparatus includes a flexion damper that applies a resisting force in a bending direction of a knee joint of a leg, a sensor that detects a switching timing in a gait cycle of the user, a control unit that switches the mode of the flexion damper in accordance with a switching timing, a detection unit that detects a predetermined state, and a transmission unit. The notification unit includes a vibration stimulation module that applies vibrations or electrical stimulation to a non-paralyzed area of the user's body and a reception unit.

### CROSS REFERENCE TO RELATED APPLICATIONS

This application is based upon and claims the benefit of priority from Japanese patent application No. 2020-144446, filed on Aug. 28, 2020, the disclosure of which is incorporated herein in its entirety by reference.

### BACKGROUND

The present disclosure relates to a walking assistance system, a walking assistance method, and a walking assistance program, and relates to, for example, a walking assistance system including a walking assistance apparatus attached to a leg of a user, a walking assistance method, and a walking assistance program.

Japanese Unexamined Patent Application Publication No. 2013-135804 discloses a walking assistance apparatus attached to a leg of a user. The walking assistance apparatus disclosed in Japanese Unexamined Patent Application Publication No. 2013-135804 includes a unit having a four-joint link mechanism that switches between a state in which knee bending is prohibited to a state in which it is allowed. This unit notifies a user of switching between the state in which knee bending is prohibited to the state in which it is allowed by emitting a sound or vibrations.

### SUMMARY

Even when a sound is emitted as a notification function for notifying switching of predetermined states such as switching between the state in which knee bending is prohibited to the state in which it is allowed, it is possible that a user cannot hear the emitted sound and thus cannot notice the notification in a noisy environment since there is a large distance between a knee and an ear. Further, even when a vibration function is provided, since a walking assistance apparatus is attached to a paralyzed leg, it is unlikely that a user will notice the notification since the capacity of the user's leg to feel any sensation has been greatly reduced. It has been required to provide a walking assistance system that enables a user to easily notice that a notification has been issued.

The present disclosure has been made to solve the aforementioned problem, and provides a walking assistance system, a walking assistance method, and a walking assistance program capable of enabling a user to easily notice a notification of a predetermined state in a walking assistance apparatus.

A walking assistance system according to this embodiment is a walking assistance system including a walking assistance apparatus attached to a leg of a user and a notification unit configured to notify the user of a predetermined state in the walking assistance apparatus, in which the walking assistance apparatus includes: a flexion damper configured to apply a resisting force in a bending direction of a knee joint of the leg; a sensor configured to detect a switching timing in a gait cycle of the user; a control unit configured to switch modes of the flexion damper in accordance with the switching timing so that a first flexion damper mode and a second flexion damper mode in which a resisting force larger than that in the first flexion damper mode is applied are alternately repeated; a detection unit configured to detect the predetermined state; a transmission unit configured to transmit the predetermined state detected by the detection unit as a signal; and the notification unit includes: a vibration stimulation module configured to apply vibrations or electrical stimulation to a non-paralyzed area of the user's body; and a reception unit configured to receive the signal transmitted from the transmission unit and operate the vibration stimulation module based on the received signal. With the above structure, it is possible to enable a user to easily notice a notification of a predetermined state in a walking assistance apparatus.

In the aforementioned walking assistance system, the walking assistance apparatus may further include an extension damper that applies a resisting force in an extending direction of a knee joint of the leg, and the control unit may operate the extension damper at an initial stage of a stance phase during which the sole of a foot is in contact with the ground. The above structure enables a patient who abruptly extends his/her knee in the stance phase to perform walking training without anxiety.

In the aforementioned walking assistance system, the flexion damper and the extension damper may be an integrated flexion/extension damper, the flexion/extension damper may include: a cylindrical body; a shaft that linearly moves inside the cylindrical body; and a cam that contacts the tip of the shaft protruded from the cylindrical body, the cam may include a V-shaped surface formed of an extension surface that the tip of the shaft contacts when the knee angle is equal to or smaller than a predetermined knee angle and a flexion surface that the tip of the shaft contacts when the knee angle is larger than the predetermined knee angle, the tip of the shaft contacts the extension surface, whereby the flexion/extension damper may operate as the extension damper, and the tip of the shaft contacts the flexion surface, whereby the flexion/extension damper may operate as the flexion damper. With the above structure, it is possible to reduce the weight of the walking assistance apparatus.

In the aforementioned walking assistance system, the notification unit may send a notification regarding the operation of the extension damper. With the above structure, the user can be notified of an operation of the extension damper.

In the aforementioned walking assistance system, the notification unit sends a notification regarding at least one of switching of the mode of the flexion damper, the residual capacity of a battery of the walking assistance apparatus, and an abnormality in the walking assistance apparatus. With the above structure, the user is able to know a predetermined state of the walking assistance apparatus.

In the aforementioned walking assistance system, the non-paralyzed area includes one of a leg to which the walking assistance apparatus is not attached, the waist, the trunk, shoulders, arms, hands, the neck, and the head. With the above structure, the user is able to easily notice a notification of a predetermined state in the walking assistance apparatus.

In the aforementioned walking assistance system, the vibration stimulation module is arranged in one of clothes, a belt, a wristband, a stick, a watch, glasses, a cap, and a necklace. With the above structure, the user is able to easily notice a notification of a predetermined state in the walking assistance apparatus.

A walking assistance method according to this embodiment is a walking assistance method using a walking assistance system including a walking assistance apparatus attached to a leg of a user and a notification unit configured to notify the user of a predetermined state in the walking assistance apparatus, in which in the walking assistance apparatus, a flexion damper is caused to apply a resisting force in a bending direction of a knee joint of the leg, a sensor is caused to detect a switching timing in a gait cycle of the user, a control unit is caused to switch the mode of the flexion damper in accordance with the switching timing in such a way that a first flexion damper mode and a second flexion damper mode in which a resisting force larger than that in the first flexion damper mode is applied are alternately repeated, a detection unit is caused to detect the predetermined state, a transmission unit is caused to transmit the predetermined state detected by the detection unit as a signal, and in the notification unit, a signal transmitted from the transmission unit is received and a vibration stimulation module that applies vibrations or electrical stimulation to a non-paralyzed area of the user's body is operated based on the received signal. With the above structure, it is possible to enable a user to easily notice a notification of a predetermined state in a walking assistance apparatus.

In the walking assistance method, in the walking assistance apparatus, an extension damper may be caused to apply a resisting force in an extending direction of the knee joint of the leg, and the control unit may be caused to operate the extension damper at an initial stage of a stance phase during which the sole of a foot is in contact with the ground. The above structure enables a patient who abruptly extends his/her knee in the stance phase to perform walking training without anxiety.

In the walking assistance method, the flexion damper and the extension damper may be an integrated flexion/extension damper, the flexion/extension damper may include: a cylindrical body; a shaft that linearly moves inside the cylindrical body; and a cam that contacts the tip of the shaft protruded from the cylindrical body, the cam may include a V-shaped surface formed of an extension surface that the tip of the shaft contacts when the knee angle is equal to or smaller than a predetermined knee angle and a flexion surface that the tip of the shaft contacts when the knee angle is larger than the predetermined knee angle, the tip of the shaft contacts the extension surface, whereby the flexion/extension damper may operate as the extension damper, and the tip of the shaft contacts the flexion surface, whereby the flexion/extension damper may operate as the flexion damper. With the above structure, it is possible to reduce the weight of the walking assistance apparatus.

The walking assistance method may include causing the notification unit to send a notification regarding an operation of the extension damper. With the above structure, the user can be notified of an operation of the extension damper.

The walking assistance method may include causing the notification unit to send a notification of at least one of switching of the mode of the flexion damper, the residual capacity of a battery of the walking assistance apparatus, and an abnormality in the walking assistance apparatus. With the above structure, the user is able to know a predetermined state of the walking assistance apparatus.

In the walking assistance method, the non-paralyzed area includes one of a leg to which the walking assistance apparatus is not attached, the waist, the trunk, shoulders, arms, hands, the neck, and the head. With the above structure, the user is able to easily notice a notification of a predetermined state in the walking assistance apparatus.

In the walking assistance method, the vibration stimulation module is arranged in one of clothes, a belt, a wristband, a stick, a watch, glasses, a cap, and a necklace. With the above structure, the user is able to easily notice a notification of a predetermined state in the walking assistance apparatus.

A walking assistance program according to this embodiment is a walking assistance program that uses a walking assistance system including a walking assistance apparatus attached to a leg of a user and a notification unit configured to notify the user of a predetermined state in the walking assistance apparatus, the walking assistance program causing a computer to execute the following: in the walking assistance apparatus, a flexion damper is caused to apply a resisting force in a bending direction of a knee joint of the leg, a sensor is caused to detect a switching timing in a gait cycle of the user, a control unit is caused to switch the mode of the flexion damper in accordance with the switching timing in such a way that a first flexion damper mode and a second flexion damper mode in which a resisting force larger than that in the first flexion damper mode is applied are alternately repeated, a detection unit is caused to detect the predetermined state, a transmission unit is caused to transmit the predetermined state detected by the detection unit as a signal, and in the notification unit, a signal transmitted from the transmission unit is received and a vibration stimulation module that applies vibrations or electrical stimulation to a non-paralyzed area of the user's body is operated based on the received signal. With the above structure, it is possible to enable a user to easily notice a notification of a predetermined state in a walking assistance apparatus.

In the walking assistance program, in the walking assistance apparatus, an extension damper may be caused to apply a resisting force in an extending direction of the knee joint of the leg, and the control unit may be caused to operate the extension damper at an initial stage of a stance phase during which the sole of a foot is in contact with the ground. The above structure enables a patient who abruptly extends his/her knee in the stance phase to perform walking training without anxiety.

In the walking assistance program, the flexion damper and the extension damper may be an integrated flexion/extension damper, the flexion/extension damper may include: a cylindrical body; a shaft that linearly moves inside the cylindrical body; and a cam that contacts the tip of the shaft protruded from the cylindrical body, the cam may include a V-shaped surface formed of an extension surface that the tip of the shaft contacts when the knee angle is equal to or smaller than a predetermined knee angle and a flexion surface that the tip of the shaft contacts when the knee angle is larger than the predetermined knee angle, the tip of the shaft may contact the extension surface, whereby the flexion/extension damper is caused to operate as the extension damper, and the tip of the shaft may contact the flexion surface, whereby the flexion/extension damper is caused to operate as the flexion damper. With the above structure, it is possible to reduce the weight of the walking assistance apparatus.

The walking assistance program may include causing the notification unit to operate the extension damper. With the above structure, the user can be notified of an operation of the extension damper.

In the walking assistance program, the notification unit may be caused to send a notification of at least one of switching of the mode of the flexion damper, the residual capacity of a battery of the walking assistance apparatus, and an abnormality in the walking assistance apparatus. With the above structure, the user is able to know a predetermined state of the walking assistance apparatus.

In the walking assistance program, the non-paralyzed area includes one of a leg to which the walking assistance apparatus is not attached, the waist, the trunk, shoulders, arms, hands, the neck, and the head. With the above structure, the user is able to easily notice a notification of a predetermined state in the walking assistance apparatus.

In the walking assistance program, the vibration stimulation module is arranged in one of clothes, a belt, a wristband, a stick, a watch, glasses, a cap, and a necklace. With the above structure, the user is able to easily notice a notification of a predetermined state in the walking assistance apparatus.

According to this embodiment, it is possible to provide a walking assistance system, a walking assistance method, and a walking assistance program capable of enabling a user to easily notice a notification of a predetermined state in a walking assistance apparatus.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic view illustrating a walking assistance system according to a first embodiment;

FIG. 2 is a front view illustrating a walking assistance apparatus in the walking assistance system according to the first embodiment;

FIG. 3 is a side view illustrating the walking assistance apparatus in the walking assistance system according to the first embodiment;

FIG. 4 is a block diagram illustrating a control system in the walking assistance system according to the first embodiment;

FIG. 5 is a diagram illustrating a walking motion and a timing at which modes are switched in a gait cycle using the walking assistance apparatus according to the first embodiment;

FIG. 6 is a block diagram illustrating a control system in a walking assistance system according to a second embodiment;

FIG. 7 is a diagram illustrating a flexion/extension damper in a walking assistance apparatus according to another example of the second embodiment; and

FIG. 8 is a diagram illustrating a walking motion and a timing at which modes are switched in a gait cycle using the walking assistance apparatus according to the second embodiment.

### DESCRIPTION OF EMBODIMENTS

Hereinafter, although the present disclosure will be described with reference to embodiments of the present disclosure, the present disclosure according to claims is not limited to the following embodiments. For the clarification of the description, the following description and the drawings may be omitted or simplified as appropriate. Throughout the drawings, the same components are denoted by the same reference signs and repeated descriptions will be omitted as appropriate.

### First Embodiment

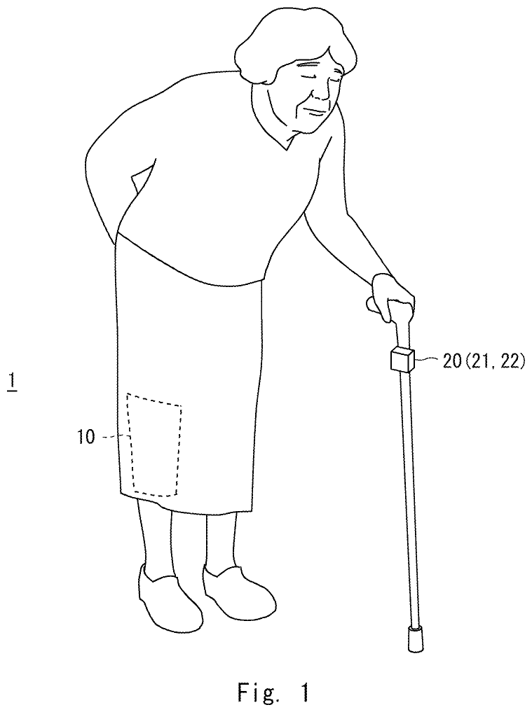

A walking assistance system according to a first embodiment will be described. The walking assistance system according to this embodiment includes, for example, a walking assistance apparatus attached to a leg including a knee joint of a trainee, who is a user, who performs walking training. FIG. 1 is a schematic view illustrating the walking assistance system according to the first embodiment. As shown in FIG. 1, a walking assistance system 1 includes a walking assistance apparatus 10 and a notification unit 20. The walking assistance apparatus 10 is attached to a leg of a user. The notification unit 20 notifies the user of a predetermined state in the walking assistance apparatus 10.

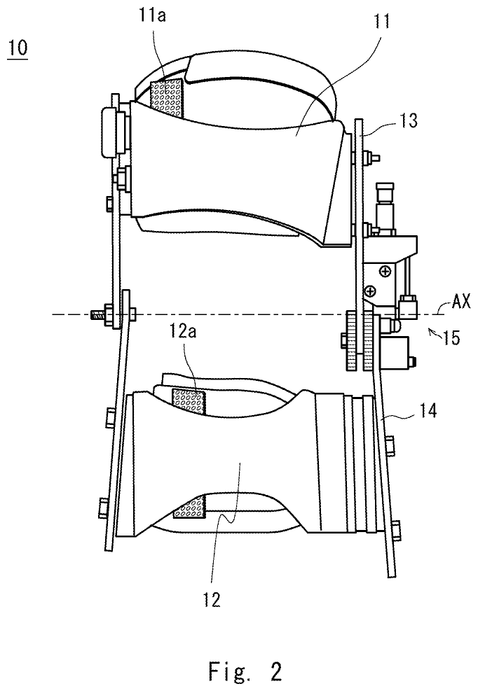

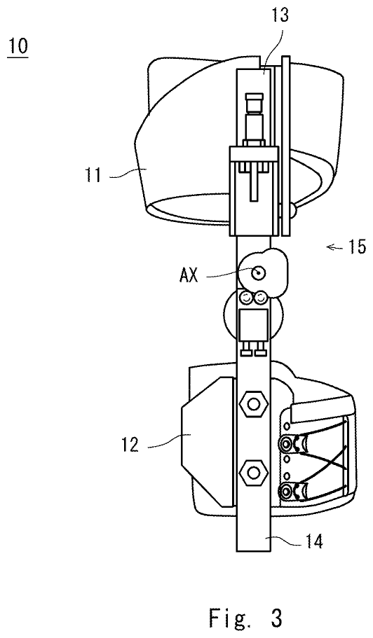

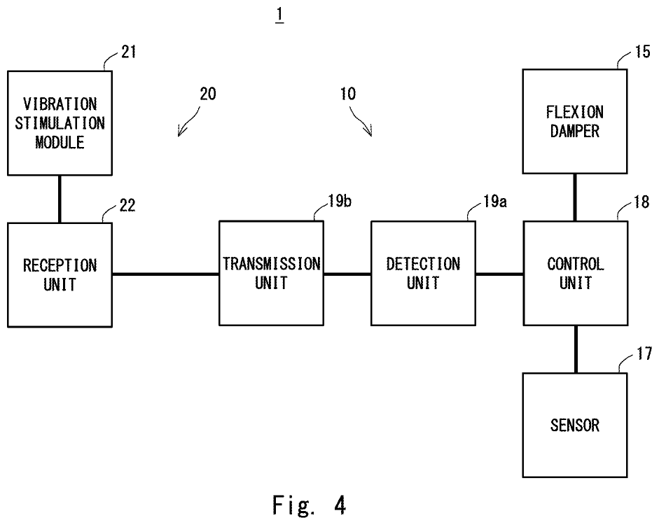

FIG. 2 is a front view illustrating the walking assistance apparatus in the walking assistance system according to the first embodiment. FIG. 3 is a side view illustrating the walking assistance apparatus in the walking assistance system according to the first embodiment. FIG. 4 is a block diagram illustrating a control system in the walking assistance system according to the first embodiment. As shown in FIGS. 1-4, the walking assistance apparatus 10 includes an upper leg supporter 11, a lower leg supporter 12, an upper leg frame 13, a lower leg frame 14, a flexion damper 15, a sensor 17, a control unit 18, a detection unit 19a, and a transmission unit 19b. A short lower-limb orthosis may be attached to a lower side of the walking assistance apparatus 10. The notification unit 20 includes a vibration stimulation module 21 and a reception unit 22. In the walking assistance system 1 according to this embodiment, structures of the walking assistance apparatus 10 and the notification unit 20 will be described first and then an operation of the walking assistance system 1 will be described.

### <Upper Leg Supporter and Lower Leg Supporter>

The upper leg supporter 11 is attached to the upper part of the leg of the user so that it is wound around it, and the lower leg supporter 12 is attached to the lower part of the leg of the user so that it is wound around it. Thus, the upper leg supporter 11 and the lower leg supporter 12 are arranged near the knee joint of the user, specifically, they are arranged over the upper leg and the lower leg of the user. Note that the upper leg indicates a part of the leg from the hip joint to the knee joint, and the lower leg indicates a part of the leg from the knee joint to the ankle joint. The lower leg includes a shin. A part of the leg below the ankle joint, that is, an end part of the leg is a foot.

The upper leg supporter 11 and the lower leg supporter 12 are formed of a stretchable material such as a resin material or a fiber material. The upper leg supporter 11 and the lower leg supporter 12 are wound around the upper leg and the lower leg, respectively, to thereby attach the walking assistance apparatus 10 to the upper leg and the lower leg. The upper leg supporter 11 and the lower leg supporter 12, respectively, may include a hook-and-loop fastener 11a and a hook-and-loop fastener 12a which are attached to the upper leg and the lower leg, respectively. A user winds the upper leg supporter 11 and the lower leg supporter 12 around his/her leg and fixes them with the hook-and-loop fasteners 11a and 12a, respectively.

The hook-and-loop fastener 11a is provided on the front side of the upper leg. The hook-and-loop fastener 12a is provided on the front side of the lower leg. By using the hook-and-loop fasteners 11a and 12a, the user can easily attach and detach the walking assistance apparatus 10. Further, the walking assistance apparatus 10 can be prevented from being displaced from the knee joint of the user. The hook-and-loop fasteners 11a and 12a allow the user to adjust the degree of compression. Further, a fixing band may be provided in order to prevent the hook-and-loop fasteners 11a and 12a from coming off or prevent the upper leg supporter 11 and the lower leg supporter 12 from being displaced.

Note that it is possible to fix the walking assistance apparatus 10 to the leg without using the hook-and-loop fasteners 11a and 12a. For example, the walking assistance apparatus 10 may be fixed to the upper leg and lower leg by using fixing member such as a belt, a button, a pin, or a band. The user can still wear the walking assistance apparatus 10 even when the fixing member described above is employed.

### <Upper Leg Frame and Lower Leg Frame>

The upper leg frame 13 is attached to a side part of the upper leg supporter 11. The upper leg frame 13 is disposed along the upper leg. The lower leg frame 14 is attached to a side part of the lower leg supporter 12. The lower leg frame 14 is disposed along the lower leg. The upper leg frame 13 and the lower leg frame 14 are connected to each other through the flexion damper 15. Specifically, the flexion damper 15 is located at the height of the knee joint so that a rotation axis Ax of the flexion damper 15 substantially coincides with the axis of the knee joint. The upper leg frame 13 and the lower leg frame 14 configure a link mechanism that is rotatable about the rotation axis Ax of the flexion damper 15.

### <Flexion Damper>

The flexion damper 15 applies a resisting force in a bending direction of the knee joint of the leg of the user. The bending direction is a direction in which the knee joint is bent in a rotational direction of the knee joint. The flexion damper 15, which is, for example, a rotary damper, is located at a side part of the knee joint. The flexion damper 15 may reduce its speed of rotation in the bending direction of the knee joint by using, for example, viscous resistance of a fluid such as oil, elastic resistance of a spring or the like, and frictional resistance of a disk or the like.

The flexion damper 15 is a one-way damper that applies a resisting force in only one direction. Therefore, the flexion damper 15 is configured to move freely so as not to apply the resisting force in an extending direction of the knee joint. The extending direction is the direction in which the knee joint extends in the rotational direction of the knee joint, the direction in which the upper leg and the lower leg are linearly extended. As will be described later, the mode of the flexion damper 15 can be switched by the control unit 18 between a first flexion damper mode and a second flexion damper mode in which the resisting force applied in the bending direction is made greater than that in the first flexion damper mode. The first flexion damper mode may be a free mode in which no resisting force is applied in the bending direction. When the first flexion damper mode is the free mode, the second flexion damper mode is referred to as a damper mode. The second flexion damper mode includes a period in which a magnitude of the resisting force is gradually increased from that of the resisting force in the first flexion damper mode.

The flexion damper 15 is connected to the control unit 18 via a wired or wireless communication line. Each mode of the flexion damper 15 is controlled by the control unit 18.

### <Sensor>

As shown in FIG. 4, the sensor 17 is connected to the control unit 18 via a wired or wireless communication line. The sensor 17 detects a timing in the walking motion of the user. Specifically, the sensor 17 is provided for detecting a switching timing in a gait cycle (a gait frequency). For example, the sensor 17 detects an angle between the ground and the lower leg, and outputs the detected angle to the control unit 18 as a result of the detection. The control unit 18 switches the modes based on the result of the detection by the sensor 17.

Specifically, the control unit 18 switches the modes of the flexion damper 15 based on the angle between the ground and the lower leg. That is, the control unit 18 switches the modes of the flexion damper 15 based on a timing signal output from the sensor 17. By this configuration, the modes of the flexion damper 15 are switched by the control unit 18 at a fixed timing in the gait cycle. Power is supplied to the sensor 17 and the control unit 18 from a battery (not shown) mounted on the walking assistance apparatus 10.

Various types of sensors can be used as the sensor 17. Specific examples of the sensor 17 will be described below.

The sensor 17 may be, for example, a gyro sensor that detects an angle of the lower leg (the shin) with respect to the ground. Further, the sensor 17 may be an angle sensor that detects an angle of the leg, that is, an angle formed by the upper leg and the lower leg around the knee joint. Further, the sensor 17 may be an angle sensor that detects a bending angle at which the lower leg is bent from a state in which the upper leg and the lower leg are linearly extended and the knee joint is thus extended. The bending angle is also referred to as a knee angle.

The sensor 17 may be an angular velocity sensor that detects an angle of the lower leg, an angle of the leg, and an angular velocity of a bending angle of the leg.

The sensor 17 may be a distance measuring sensor that detects a distance between a predetermined position of the leg and the ground. The predetermined position of the leg is, for example, a shoe, a foot, a sole of a foot, or the like. For example, the distance measuring sensor attached in a shoe, a foot, or the vicinity thereof can be used as the sensor 17. As the distance from a shoe, a foot, a sole of a foot, or the like to the ground varies in accordance with the walking motion, a waveform corresponding to the gait cycle can be detected. Note that an optical sensor can be used as the distance measuring sensor. Further, the ground includes a floor surface.

The sensor 17 detects a waveform corresponding to the gait cycle from the detected angles, angular velocities, distances, and the like. That is, the detected angles, angular velocities, distances, and the like are periodically changed in accordance with the gait cycle. The sensor 17 detects a walking timing based on the detected angles, angular velocities, distances, and the like.

For example, the control unit 18 may compare the output value of the sensor 17 with a threshold and switch the modes of the flexion damper 15 in accordance with the result of the comparison. For example, the control unit 18 switches the modes in accordance with a timing signal indicating the timing at which the output value of the sensor 17 exceeds the threshold or a timing signal indicating the timing at which the output value thereof falls below the threshold.

Note that in the flexion damper 15, a first threshold (e.g., a first angle of the lower leg) for detecting a switching timing at which the modes are switched from the first flexion damper mode to the second flexion damper mode and a second threshold (e.g., a second angle of the lower leg) for detecting a switching timing at which the modes are switched from the second flexion damper mode to the first flexion damper mode may be set.

Further, the sensor 17 may be a ground contact timing sensor that detects a ground contact timing (i.e., a timing at which the sole of the foot comes into contact with the ground) of the sole of the foot. The sensor 17 can detect the walking timing based on the detected ground contact timing. For example, the sensor 17 detects the switching timing by adding or subtracting in advance the time from the ground contact timing to the switching timing of each mode.

Further, the sensor 17 may be an imaging sensor that shoots the leg. In this case, the sensor 17 shoots the state of the leg from the outside of the walking assistance apparatus 10. The walking timing can be detected from the state of the shot leg. Note that when the sensor 17 is disposed outside the walking assistance apparatus 10, the walking assistance apparatus 10 may include a reception unit that receives a signal indicating the switching timing from the external sensor 17.

Further, the switching timing may be detected using a plurality of sensors 17 in combination. For example, the sensor 17 may include both of a first sensor for detecting the angle of the lower leg and a second sensor for detecting the distance from the sole of the foot to the floor surface. As a matter of course, the specific examples of the sensor 17 are not limited to the aforementioned examples. The sensor 17 may be mounted on the walking assistance apparatus 10. Alternatively, the sensor 17 may be mounted outside the walking assistance apparatus 10.

### <Control Unit>

The control unit 18 is connected to the flexion damper 15, the sensor 17, and the detection unit 19a via a wired or wireless communication line. The control unit 18 controls the flexion damper 15 based on the switching timing output from the sensor 17. The control unit 18 switches the modes of the flexion damper 15.

The control unit 18 switches the modes of the flexion damper 15 in accordance with the switching timing in such a way that the first flexion damper mode and the second flexion damper mode are repeated alternately. For example, in the first flexion damper mode, the flexion damper 15 is turned off to be brought into the free mode in which no resisting force is applied in the bending direction. In the second flexion damper mode, the flexion damper 15 is turned on to be brought into the damper mode in which a resisting force is applied in the bending direction. Alternatively, for example, in the first flexion damper mode, the flexion damper 15 is switched so as to apply a small resisting force, and in the second flexion damper mode, the flexion damper 15 is switched so as to apply a large resisting force.

### <Detection Unit>

The detection unit 19a is connected to the control unit 18 and the transmission unit 19b via a wired or wireless communication line. The detection unit 19a detects a predetermined state of the walking assistance apparatus 10. The predetermined state is, for example, a mode of the flexion damper 15 in the walking assistance apparatus 10. The detection unit 19a may detect either a timing when the first flexion damper mode is switched to the second flexion damper mode or a timing when the second flexion damper mode is switched to the first flexion damper mode.

Further, the detection unit 19a may detect whether the operation of the walking assistance apparatus 10 is normal or abnormal. The detection unit 19a may detect an abnormal operation of the flexion damper 15 by comparing, for example, the operation of the flexion damper 15 with an operation of the flexion damper 15 set in advance. Further, the detection unit 19a monitors, for example, a control signal transmitted from the control unit 18 to the flexion damper 15. The detection unit 19a detects whether each signal is a preset signal. In this manner, the detection unit 19a is able to detect whether or not the flexion damper 15 and the control unit 18 are normal. Thus, the detection unit 19a is able to detect occurrence of an abnormality in the walking assistance apparatus 10.

Further, the detection unit 19a may detect the residual capacity of the battery provided in the walking assistance apparatus 10. The detection unit 19a detects whether or not the residual capacity of the battery set in advance falls below a predetermined threshold. The detection unit 19a outputs the detected predetermined state to the transmission unit 19b.

### <Transmission Unit>

The transmission unit 19b is connected to the detection unit 19a and the reception unit 22 via a wired or wireless communication line. The transmission unit 19b transmits a signal indicating the predetermined state of the walking assistance apparatus 10 detected by the detection unit 19a to the reception unit 22 of the notification unit 20.

### <Vibration Stimulation Module>

Next, a configuration of the notification unit 20 will be described. The vibration stimulation module 21 is connected to the reception unit 22 via a wired or wireless communication line. The vibration stimulation module 21 applies vibrations or electrical stimulation to a non-paralyzed area of the user's body. The user's body includes a paralyzed area and a non-paralyzed area. The paralyzed area of the user's body is, for example, a leg to which the walking assistance apparatus 10 is attached. The non-paralyzed area of the user's body is a part of the user's body other than the paralyzed area. When, for example, one leg of the user is the paralyzed area and the walking assistance apparatus 10 is attached to this leg, the non-paralyzed area of the user's body includes the other leg to which the walking assistance apparatus 10 is not attached, the waist, the trunk, the shoulders, the arms, the hands, the neck, and the head.

The vibration stimulation module 21 may be provided in clothes, a belt, a cap, a wristband or the like attached to a non-paralyzed area so as to apply vibrations or electrical stimulation to a non-paralyzed area of the user's body or may be provided in a stick, a watch, glasses, a necklace or the like that the user owns.

### <Reception Unit>

The reception unit 22 is connected to the transmission unit 19b and the vibration stimulation module 21 via a wired or wireless communication line. The reception unit 22 receives a signal transmitted from the transmission unit 19b. The reception unit 22 operates the vibration stimulation module 21 based on the signal received from the transmission unit 19b.

### <Operation>

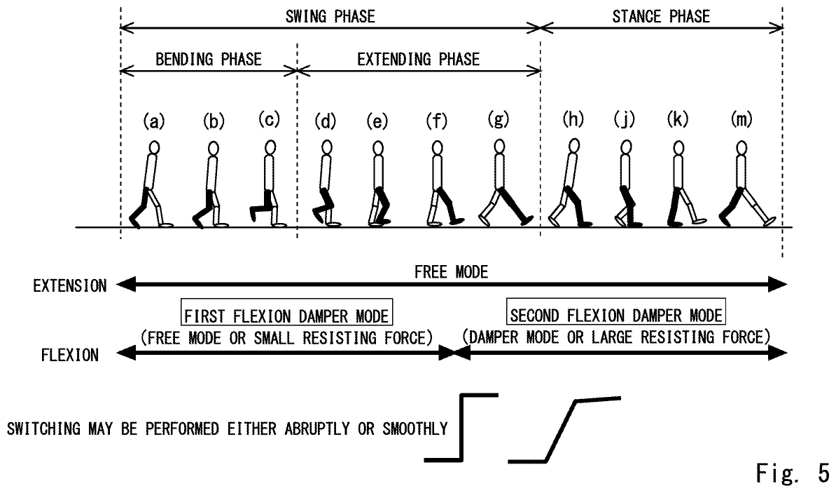

Next, an operation of the walking assistance system 1 will be described. FIG. 5 is a diagram illustrating a walking motion and a timing at which the modes are switched in the gait cycle using the walking assistance system according to the first embodiment. First, with reference to FIG. 5, one gait cycle including a swing phase and a stance phase will be described. Next, a walking motion and a timing at which the modes are switched according to this embodiment will be described. After that, detection of a predetermined state and notification of a predetermined state in the walking assistance apparatus 10 will be described.

### <One Gait Cycle>

As shown in FIG. 5, one gait cycle includes two steps, that is, one left-leg step and one right-leg step. In FIG. 5, one gait cycle is shown in the order of timings (a) to (m). After the timing (m), the timing returns to the timing (a) to start the next gait cycle. In FIG. 5, the timings from (a) to (g) are in a swing phase, and the timings from (h) to (m) are in a stance phase.

In the swing phase, the sole of the foot of the leg to which the walking assistance apparatus 10 is attached comes off the ground, and in the stance phase, the sole of the foot of the leg to which the walking assistance apparatus 10 is attached is in contact with the ground. Between the timing (g) and the timing (h), the sole of the foot comes into contact with the ground, and between the timing (m) and the timing (a), the sole of the foot comes off the ground. The timings (a) to (c) are in a bending phase during which a bending angle of the knee joint is increased, and the timings (d) to (g) are in an extending phase during which the bending angle of the knee joint is reduced. Note that the swing phase, the stance phase, the bending phase, and the extending phase are set based on the diseased leg to which the walking assistance apparatus 10 is attached.

### <Bending Direction>

Next, a walking motion and a timing at which the modes are switched in the above-described one gait cycle will be described. First, the operation of the flexion damper 15 that applies a resisting force in the bending direction of the knee joint will be described. In this embodiment, the mode of the flexion damper 15 is switched from the first flexion damper mode to the second flexion damper mode in the extending phase, specifically, at the timing (f). Further, the mode of the flexion damper 15 is switched from the second flexion damper mode to the first flexion damper mode at the timing when the phase is changed from the stance phase to the swing phase, specifically, between the timing (m) and the timing (a).

The first flexion damper mode includes a free mode in which a resisting force is not applied in the bending direction of the knee joint or a mode in which a resisting force smaller than that in the second flexion damper mode is applied in the bending direction of the knee joint. The second flexion damper mode includes a damper mode in which a resisting force is applied in the bending direction of the knee joint or a mode in which a resisting force larger than that in the first flexion damper mode is applied in the bending direction of the knee joint.

In the swing phase, it is not necessary to support the weight of a user with the diseased leg. Therefore, in the swing phase, it is not necessary to generate a resisting force with respect to the knee joint by the flexion damper 15, or it is sufficient to generate a small amount of resisting force even when it is necessary to generate the resisting force. Thus, during most of the swing phase, in regard to the bending direction, the control unit 18 can set the mode to the first flexion damper mode including the free mode. Meanwhile, during the entire stance phase, the control unit 18 sets the mode to the second flexion damper mode, where a resisting force is generated with respect to the flexion damper 15 in the bending direction.

Further, in the one gait cycle, only the first and second flexion damper modes are set, and the control unit 18 alternately switches the first and second flexion damper modes during the walking motion. That is, the control unit 18 controls the flexion damper 15 based on the timing signal. For example, the control unit 18 preforms on-off control of the free mode and the damper mode. By doing so, it is possible to perform an appropriate control with a simple configuration. For example, when the walking motion varies for each gait cycle, the switching timings detected by the sensor 17 may vary. Even in this case, at the timing before the phase is switched from the swing phase to the stance phase, that is, at any timing in the extending phase, it is only necessary to switch the mode of the flexion damper 15 from the first flexion damper mode to the second flexion damper mode.

Specifically, it is only necessary for the control unit 18 to switch the modes at a predetermined timing between the timings (d) to (g). Since the margin for the errors in the switching timings detected by the sensor 17 can be widened, an appropriate control can be performed. Further, in the extending phase, the knee joint is gradually rotated in the extending direction from a bending state. Therefore, even when the flexion damper 15 is in the second flexion damper mode, no resisting force is generated. Thus, it is possible to switch the modes without the walking motion of a user being interrupted by the flexion damper 15.

Further, the flexion damper 15 moves freely and thus generates no resisting force in the extending direction of the knee joint. Therefore, a user can freely extend his/her knee joint. Further, as there is no lock mode for locking the flexion damper 15 between the second flexion damper mode including the damper mode and the first flexion damper mode including the free mode, it is possible to prevent the flexion damper 15 from interrupting the walking motion. As the mode is changed from the second flexion damper mode to the first flexion damper mode without being changed to the lock mode, it is possible to easily perform an appropriate control.

The switching timings between the swing phase and the stance phase in accordance with the outputs of the sensor 17 may be detected, so that the first flexion damper mode is set for the swing phase and the second flexion damper mode is set for the stance phase. That is, the timing at which the phase is changed from the swing phase to the stance phase and the timing at which the phase is changed from the stance phase to the swing phase may be set to the switching timings of the modes of the flexion damper 15.

Further, the switching between the first and the second flexion damper modes may be performed abruptly or smoothly. That is, the second flexion damper mode may include a period in which a magnitude of a resisting force is gradually increased from that of the resisting force in the first flexion damper mode, or a period in which a magnitude of a resisting force is gradually reduced until it becomes that of the resisting force in the first flexion damper mode.

### <Extending Direction>

Next, a motion of the knee joint in the extending direction will be described. In this embodiment, the extension damper is not provided or the extension damper is not operated. Further, the flexion damper 15 generates no resistance force in the extending direction. Thus, in this embodiment, the knee joint can be moved freely in the extending direction during the entire gait cycle.

### <Detection of Predetermined State and Notification of Predetermined State>

The detection unit 19a detects at least one of a timing when the first flexion damper mode is switched to the second flexion damper mode and a timing when the second flexion damper mode is switched to the first flexion damper mode as a predetermined state in the walking assistance apparatus 10. Further, the detection unit 19a may detect occurrence of an abnormality in the walking assistance apparatus 10 as a predetermined state in the walking assistance apparatus 10. Further, the detection unit 19a may detect the residual capacity of the battery as a predetermined state in the walking assistance apparatus 10. The detection unit 19a outputs the detected predetermined state to the transmission unit 19b as a signal.

The transmission unit 19b receives a predetermined state detected by the detection unit 19a and transmits the received predetermined state to the reception unit 22 of the notification unit 20 as a signal. The reception unit 22 receives the signal transmitted from the transmission unit 19b. The reception unit 22 operates the vibration stimulation module 21 based on the signal received from the transmission unit 19b. The vibration stimulation module 21 applies vibrations or electrical stimulation to a non-paralyzed area of the user's body. The user is therefore able to easily notice a notification of a predetermined state in the walking assistance apparatus 10.

Next, effects of this embodiment will be described. When the detection unit 19a has detected a predetermined state in the walking assistance apparatus 10 in the walking assistance system 1 according to this embodiment, the vibration stimulation module 21 applies vibrations or electrical stimulation to a non-paralyzed area of the user's body. Accordingly, the user is able to easily notice a notification of a predetermined state in the walking assistance apparatus 10.

Further, the vibration stimulation module 21 is arranged in clothes, a belt, a wristband, a stick, a watch, glasses, a cap, a necklace or the like. The non-paralyzed area includes a leg to which the walking assistance apparatus 10 is not attached, the waist, the trunk, shoulders, arms, hands, the neck, the head or the like. Therefore, the user is able to notice a notification of a predetermined state in the walking assistance apparatus 10.

The notification unit 20 notifies the user of switching of the modes of the flexion damper 15 as the predetermined state of the walking assistance apparatus 10. Therefore, the user is able to know that the mode of the flexion damper 15 will be switched. Accordingly, the user is able to prepare for the switching of the modes of the flexion damper 15 in advance, and is able to perform walking training without anxiety.

The notification unit 20 further notifies the user of an abnormality in the walking assistance apparatus 10. Since the user is able to use the walking assistance apparatus 10 that normally operates, the user is able to perform walking training without anxiety. The notification unit 20 further notifies the user of the residual capacity of the battery as the predetermined state of the walking assistance apparatus 10. Accordingly, since the user is able to know the residual capacity of the battery, it is possible to prevent the battery from running out during the walking training.

### Second Embodiment

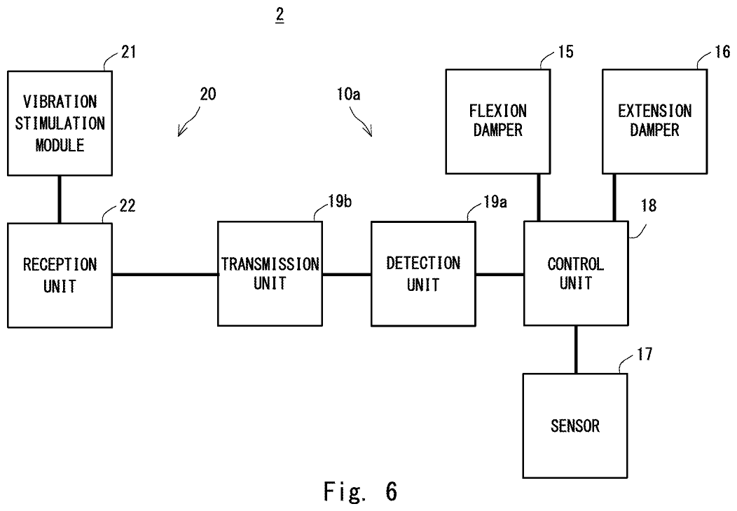

Next, a walking assistance system according to a second embodiment will be described. In the walking assistance system according to this embodiment, a walking assistance apparatus includes an extension damper that applies a resisting force in an extending direction. FIG. 6 is a block diagram illustrating a control system in the walking assistance system according to the second embodiment.

As shown in FIG. 6, in a walking assistance system 2 according to this embodiment, a walking assistance apparatus 10a includes an extension damper 16. The extension damper 16 is connected to the control unit 18 via a wired or wireless communication line. The extension damper 16 applies a resisting force in an extending direction of a knee joint of a leg.

The extension damper 16 is disposed in the part where the upper leg frame 13 is connected to the lower leg frame 14 together with the flexion damper 15. Specifically, the upper leg frame 13 and the lower leg frame 14 are connected to each other through the flexion damper 15 and the extension damper 16. Specifically, the flexion damper 15 and the extension damper 16 are located at the height of the knee joint so that a rotation axis Ax of the flexion damper 15 and extension damper 16 substantially coincides with the axis of the knee joint. The upper leg frame 13 and the lower leg frame 14 configure a link mechanism that is rotatable about the rotation axis Ax of the flexion damper 15 and the extension damper 16.

The extension damper 16, which is, for example, a rotary damper, is located at a side part of the knee joint. The extension damper 16 may reduce its speed of rotation in the extending direction of the knee joint by using, for example, viscous resistance of a fluid such as oil, elastic resistance of a spring or the like, and frictional resistance of a disk or the like. The extension damper 16 may switch the resisting force by varying the resistance. The extension damper 16 may gradually change the magnitude of the resisting force.

The extension damper 16 is a one-way damper that applies a resisting force in only one direction. Therefore, the extension damper 16 is configured to move freely so as not to apply the resisting force in a bending direction of the knee joint. The mode of the extension damper 16 can be switched by the control unit 18 between a first extension damper mode and a second extension damper mode in which a resisting force in the extending direction larger than that in the first extension damper mode is applied. The first extension damper mode may be a free mode in which no resisting force is applied in the extending direction. When the first extension damper mode is the free mode, the second extension damper mode is referred to as a damper mode. The second extension damper mode includes a period in which a magnitude of the resisting force is gradually increased from that of the resisting force in the first extension damper mode.

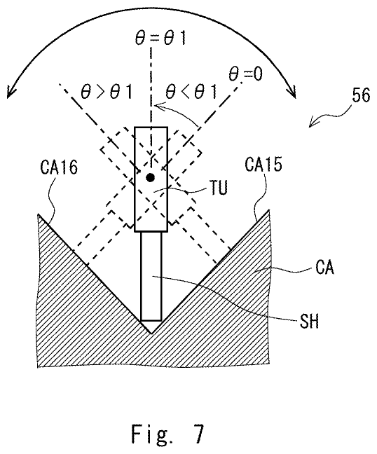

FIG. 7 is a diagram illustrating a flexion/extension damper in the walking assistance apparatus according to another example of the second embodiment. While the flexion damper 15 and the extension damper 16 have been described as separate components in the aforementioned example, a flexion/extension damper 56 in which the flexion damper 15 and the extension damper 16 are integrated may be provided, as shown in FIG. 7. The flexion/extension damper 56 includes a cylindrical body TU, a shaft SH that linearly moves inside the cylindrical body TU, and a cam CA that contacts the tip of the shaft SH protruded from the cylindrical body TU. The flexion/extension damper 56 is a stroke damper in which the shaft SH linearly moves. The flexion/extension damper 56 causes the shaft SH to move inside the cylindrical body TU by pressing the shaft SH by the cam CA. The flexion/extension damper 56 generates a resisting force when the shaft SH moves to the inside of the cylindrical body TU.

In the flexion/extension damper 56, the shape of the surface of the cam CA (the flexion surface CA15 and the extension surface CA16) that the tip of the shaft SH contacts is formed to be a V shape so that the flexion damper 15 and the extension damper 16 are integrated in the flexion/extension damper 56. The flexion/extension damper 56 is rotated in conjunction with the rotation of the knee joint. At a rotation angle of the knee joint, the flexion damper and the extension damper are operated with a predetermined angle as a boundary.

Specifically, the bending angle at which the lower leg is bent from the state in which the upper leg and the lower leg are linearly extended and the knee joint is extended is referred to as a knee angle θ. When the knee angle θ is equal to or smaller than a predetermined knee angle θ1, the knee joint is rather extended. On the other hand, when the knee angle θ is larger than the predetermined knee angle θ1, the knee joint is considerably bent.

When the knee angle θ is equal to or smaller than the predetermined knee angle θ1, the shaft SH of the flexion/extension damper 56 comes in contact with the extension surface CA16 of the cam CA. Accordingly, the flexion/extension damper 56 applies a resisting force in the extending direction of the knee joint. On the other hand, when the rotation angle of the knee joint is larger than the predetermined angle θ1, the shaft SH of the flexion/extension damper 56 comes in contact with the flexion surface CA15 of the cam CA. Accordingly, the flexion/extension damper 56 applies a resisting force in the bending direction of the knee joint.

Specifically, the cam CA includes a V-shaped surface formed of the extension surface CA16 that the tip of the shaft SH contacts when the knee angle is equal to or smaller than the predetermined knee angle θ1 and the flexion surface CA15 that the tip of the shaft SH contacts when the knee angle is larger than the predetermined knee angle θ1. As the tip of the shaft SH comes in contact with the extension surface CA16, the flexion/extension damper 56 operates as an extension damper. As the tip of the shaft SH comes in contact with the flexion surface CA15, the flexion/extension damper 56 operates as a flexion damper. In this manner, the flexion/extension damper 56 applies a resisting force in the extending direction of the knee joint and applies a resisting force in the bending direction of the knee joint. Therefore, the flexion damper 15 and/or the extension damper 16 may be replaced by the flexion/extension damper 56.

There are some patients who abruptly extend their knees in the stance phase. This is due to, for example, muscle tone or because a patient may be afraid of bending their knees. This abrupt knee extension in the stance phase is not correct walking. Moreover, it is possible that these patients may lose their balance. The aforementioned walking assistance apparatus 10 according to the first embodiment is in the free mode in the extending direction. It is therefore impossible to prevent abrupt knee extension in the stance phase.

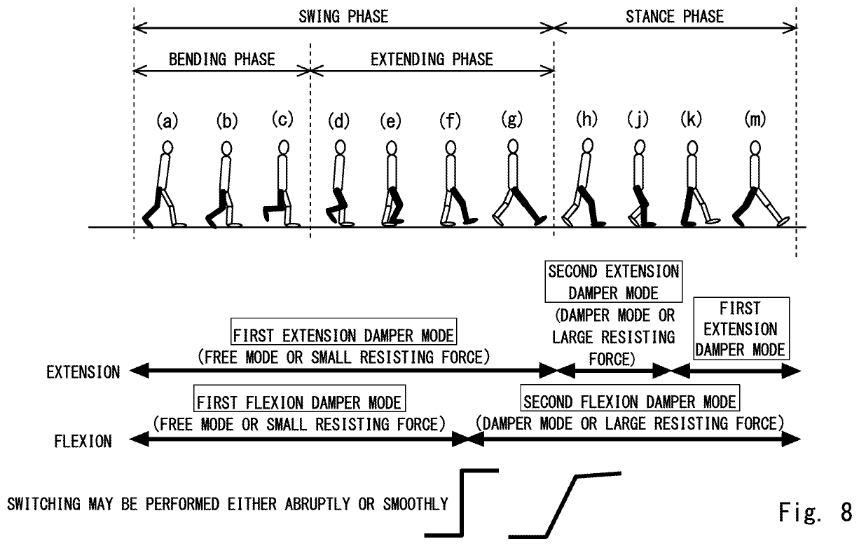

FIG. 8 is a diagram illustrating a walking motion and a timing at which modes are switched in a gait cycle using the walking assistance apparatus according to the second embodiment. As shown in FIG. 8, in this embodiment, a motion of the extending direction includes a first extension damper mode and a second extension damper mode, unlike the first embodiment. Then the first extension damper mode and the second extension damper mode are alternately switched. Specifically, in the stance phase, for example, at the timing (h), the first extension damper mode is switched to the second extension damper mode.

In this manner, the control unit 18 switches the first extension damper mode to the second extension damper mode when the sole of the foot of the leg to which the walking assistance apparatus 10 is attached comes into contact with the ground. That is, the control unit 18 switches the first extension damper mode to the second extension damper mode at an initial stage of the stance phase. The control unit 18 is able to adjust the timing when the second extension damper mode is started in accordance with the degree of extension of the knee joint of a user (i.e., how much the knee joint of a user can be extended).

For example, for a user who has severe symptoms and extends his/her knee abruptly, the control unit 18 starts the second extension damper mode at an early timing (e.g., at the timing (g)). On the other hand, for a user who extends his/her knee normally, the control unit 18 starts the second extension damper mode at the timing of the initial stage of the stance phase (e.g., at the timing (j)). The control unit 18 can adjust the start timing of the second extension damper mode by setting it in advance.

Further, the control unit 18 can adjust the start timing of the second extension damper mode based on a walking state detected by the sensor 17. The control unit 18 may adjust the start timing while a user is walking based on the various angles, the angular velocities, the distances, and the like detected by the sensor 17.

Meanwhile, the control unit 18 switches the second extension damper mode to the first extension damper mode at the timing when the phase is changed to a later stage of the stance phase, specifically, between the timing (j) and the timing (k).

Further, the switching between the first and the second extension damper modes may be performed abruptly or smoothly. That is, the second extension damper mode may include a period in which a magnitude of a resisting force is gradually increased from that of the resisting force in the first extension damper mode, or a period in which a magnitude of a resisting force is gradually reduced until it becomes equal to that of the resisting force in the first extension damper mode.

In this manner, the control unit 18 switches the modes of the extension damper depending on the switching timing in such a way that the first extension damper mode and the second extension damper mode in which a resisting force larger than that in the first extension damper mode is applied are alternately repeated.

When the first extension damper mode is the free mode, the second extension damper mode is the damper mode. Therefore, the control unit 18 operates the extension damper 16 at least in an initial stage of the stance phase during which the sole of a foot is in contact with the ground. Then the control unit 18 makes the extension damper 16 move freely in a later stage of the stance phase. Note that the control unit 18 may lock the extension damper 16 at the initial stage of the stance phase depending on the condition of the knee extension. Accordingly, the knee joint is fixed, whereby it is possible to prevent the knee from being extended at the initial stage of the stance phase.

In this embodiment, the notification unit 20 notifies the user of a motion of the extension damper 16. For example, the detection unit 19a detects at least one of a timing when the first extension damper mode is switched to the second extension damper mode and a timing when the second extension damper mode is switched to the first extension damper mode. Then the vibration stimulation module 21 notifies the user of the switching timing detected by the detection unit 19a by vibrations or electrical stimulation.

In this embodiment, for a patient who extends his/her knee abruptly in the stance phase, the walking assistance apparatus 10a operates the extension damper 16 in the initial stage of the stance phase during which the sole of the foot is in contact with the ground. In this case, a patient, who is a user, is able to know that the walking assistance apparatus 10a operates the extension damper 16 because of his/her abrupt knee extension in the stance phase. Therefore, the user is able to prepare for the operation of the extension damper 16 in advance. The user is therefore able to perform walking training without anxiety. The structures and the effects other than those stated above are included in the description with regard to the first embodiment.

Note that the present disclosure is not limited to the above-described embodiments and may be changed as appropriate without departing from the spirit of the present disclosure. For example, a structure in which the structure according to the first embodiment is combined with that according to the second embodiment is also within the scope of the technical ideas of the above-described embodiments. Further, a walking assistance method that uses a walking assistance system including a walking assistance apparatus attached to a leg of a user and a notification unit configured to notify the user of a predetermined state in the walking assistance apparatus, and a walking assistance program that uses a walking assistance system including a walking assistance apparatus attached to a leg of a user and a notification unit configured to notify the user of a predetermined state in the walking assistance apparatus are also within the scope of the technical ideas of the above-described embodiments.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A walking assistance system comprising a walking assistance apparatus attached to a leg of a user and a notification unit configured to notify the user of a predetermined state in the walking assistance apparatus, wherein
the walking assistance apparatus comprises:
a flexion damper configured to apply a resisting force in a bending direction of a knee joint of the leg;
a sensor configured to detect a switching timing in a gait cycle of the user;
a control unit configured to switch a mode of the flexion damper in accordance with the switching timing so that a first flexion damper mode and a second flexion damper mode in which a resisting force larger than that in the first flexion damper mode is applied are alternately repeated;
a detection unit configured to detect the predetermined state;
a transmission unit configured to transmit the predetermined state detected by the detection unit as a signal; and
the notification unit comprises:
a vibration stimulation module configured to apply vibrations or electrical stimulation to a non-paralyzed area of a body of the user; and
a reception unit configured to receive the signal transmitted from the transmission unit and operate the vibration stimulation module based on the received signal.

2. The walking assistance system according to claim 1, wherein
the walking assistance apparatus further comprises an extension damper that applies a resisting force in an extending direction of a knee joint of the leg, and
the control unit operates the extension damper at an initial stage of a stance phase during which a sole of a foot is in contact with a ground.

3. The walking assistance system according to claim 2, wherein
the flexion damper and the extension damper are an integrated flexion/extension damper,
the flexion/extension damper comprises:
a cylindrical body;
a shaft that linearly moves inside the cylindrical body; and
a cam that contacts a tip of the shaft protruded from the cylindrical body,
the cam includes a V-shaped surface formed of an extension surface that the tip of the shaft contacts when a knee angle is equal to or smaller than a predetermined knee angle and a flexion surface that the tip of the shaft contacts when the knee angle is larger than the predetermined knee angle,
the tip of the shaft contacts the extension surface, whereby the flexion/extension damper operates as the extension damper, and
the tip of the shaft contacts the flexion surface, whereby the flexion/extension damper operates as the flexion damper.

4. The walking assistance system according to claim 2, wherein the notification unit sends a notification regarding an operation of the extension damper.

5. The walking assistance system according to claim 1, wherein the notification unit sends a notification regarding at least one of switching of the mode of the flexion damper, a residual capacity of a battery of the walking assistance apparatus, and an abnormality in the walking assistance apparatus.

6. The walking assistance system according to claim 1, wherein the non-paralyzed area includes one of a leg to which the walking assistance apparatus is not attached, a waist, a trunk, shoulders, arms, hands, a neck, and a head.

7. The walking assistance system according to claim 1, wherein the vibration stimulation module is arranged in one of clothes, a belt, a wristband, a stick, a watch, glasses, a cap, and a necklace.

8. A walking assistance method using a walking assistance system comprising a walking assistance apparatus attached to a leg of a user and a notification unit configured to notify the user of a predetermined state in the walking assistance apparatus, wherein
in the walking assistance apparatus,
a flexion damper is caused to apply a resisting force in a bending direction of a knee joint of the leg,
a sensor is caused to detect a switching timing in a gait cycle of the user,
a control unit is caused to switch a mode of the flexion damper in accordance with the switching timing in such a way that a first flexion damper mode and a second flexion damper mode in which a resisting force larger than that in the first flexion damper mode is applied are alternately repeated,
a detection unit is caused to detect the predetermined state,
a transmission unit is caused to transmit the predetermined state detected by the detection unit as a signal, and
in the notification unit,
a signal transmitted from the transmission unit is received and a vibration stimulation module that applies vibrations or electrical stimulation to a non-paralyzed area of a body of the user is operated based on the received signal.

9. The walking assistance method according to claim 8, wherein
in the walking assistance apparatus,
an extension damper is caused to apply a resisting force in an extending direction of the knee joint of the leg, and
the control unit is caused to operate the extension damper at an initial stage of a stance phase during which a sole of a foot is in contact with a ground.

10. The walking assistance method according to claim 9, wherein
the flexion damper and the extension damper are an integrated flexion/extension damper,
the flexion/extension damper comprises:
a cylindrical body;
a shaft that linearly moves inside the cylindrical body; and
a cam that contacts a tip of the shaft protruded from the cylindrical body,
the cam includes a V-shaped surface formed of an extension surface that the tip of the shaft contacts when a knee angle is equal to or smaller than a predetermined knee angle and a flexion surface that the tip of the shaft contacts when the knee angle is larger than the predetermined knee angle,
the tip of the shaft contacts the extension surface, whereby the flexion/extension damper operates as the extension damper, and
the tip of the shaft contacts the flexion surface, whereby the flexion/extension damper operates as the flexion damper.

11. The walking assistance method according to claim 9, comprising causing the notification unit to send a notification regarding an operation of the extension damper.

12. The walking assistance method according to claims 8, comprising causing the notification unit to send a notification of at least one of switching of the mode of the flexion damper, a residual capacity of a battery of the walking assistance apparatus, and an abnormality in the walking assistance apparatus.

13. The walking assistance method according to claim 8, wherein the non-paralyzed area includes one of a leg to which the walking assistance apparatus is not attached, a waist, a trunk, shoulders, arms, hands, a neck, and a head.

14. The walking assistance method according to claim 8, wherein the vibration stimulation module is arranged in one of clothes, a belt, a wristband, a stick, a watch, glasses, a cap, and a necklace.

15. A non-transitory computer readable medium storing a walking assistance program that uses a walking assistance system comprising a walking assistance apparatus attached to a leg of a user and a notification unit configured to notify the user of a predetermined state in the walking assistance apparatus, the walking assistance program causing a computer to execute the following:
in the walking assistance apparatus,
a flexion damper is caused to apply a resisting force in a bending direction of a knee joint of the leg,
a sensor is caused to detect a switching timing in a gait cycle of the user,
a control unit is caused to switch a mode of the flexion damper in accordance with the switching timing in such a way that a first flexion damper mode and a second flexion damper mode in which a resisting force larger than that in the first flexion damper mode is applied are alternately repeated,
a detection unit is caused to detect the predetermined state,
a transmission unit is caused to transmit the predetermined state detected by the detection unit as a signal, and
in the notification unit,
a signal transmitted from the transmission unit is received and a vibration stimulation module that applies vibrations or electrical stimulation to a non-paralyzed area of a body of the user is operated based on the received signal.

16. The non-transitory computer readable medium storing the walking assistance program according to claim 15, wherein
in the walking assistance apparatus,
an extension damper is caused to apply a resisting force in an extending direction of the knee joint of the leg, and
the control unit is caused to operate the extension damper at an initial stage of a stance phase during which the sole of a foot is in contact with the ground.

17. The non-transitory computer readable medium storing the walking assistance program according to claim 16, wherein
the flexion damper and the extension damper are an integrated flexion/extension damper,
the flexion/extension damper comprises:
a cylindrical body;
a shaft that linearly moves inside the cylindrical body; and
a cam that contacts a tip of the shaft protruded from the cylindrical body,
the cam includes a V-shaped surface formed of an extension surface that the tip of the shaft contacts when a knee angle is equal to or smaller than a predetermined knee angle and a flexion surface that the tip of the shaft contacts when the knee angle is larger than the predetermined knee angle,
the tip of the shaft contacts the extension surface, whereby the flexion/extension damper is caused to operate as the extension damper, and
the tip of the shaft contacts the flexion surface, whereby the flexion/extension damper is caused to operate as the flexion damper.

18. The non-transitory computer readable medium storing the walking assistance program according to claim 16, comprising causing the notification unit to operate the extension damper.

19. The non-transitory computer readable medium storing the walking assistance program according to claim 15, wherein the notification unit is caused to send a notification of at least one of switching of the mode of the flexion damper, a residual capacity of a battery of the walking assistance apparatus, and an abnormality in the walking assistance apparatus.

20. The non-transitory computer readable medium storing the walking assistance program according to claim 15, wherein the non-paralyzed area includes one of a leg to which the walking assistance apparatus is not attached, a waist, a trunk, shoulders, arms, hands, a neck, and a head.
